(19) United States
(12) Patent Application Publication
(10) Pub. No.: US 2017/0195559 A1
(43) Pub. Date: Jul. 6, 2017

(54) INFORMATION PROCESSING DEVICE, IMAGING DEVICE, IMAGING SYSTEM, METHOD OF CONTROLLING INFORMATION PROCESSING DEVICE AND PROGRAM

(71) Applicant: SONY CORPORATION, TOKYO (JP)

(72) Inventors: RYOGO ITO, TOKYO (JP); MEGUMI TAKAGI, KANAGAWA (JP); YOKO FUKATA, TOKYO (JP); KAZUMA AKAMATSU, TOKYO (JP); SHIRO ESHITA, TOKYO (JP)

(21) Appl. No.: 15/314,586

(22) PCT Filed: Mar. 4, 2015
(86) PCT No.: PCT/JP2015/056291

§ 371 Date: Nov. 29, 2016

(30) Foreign Application Priority Data
Jun. 19, 2014 (JP) 2014-126363

(51) Int. Cl. H04N 5/232; H04N 5/93; H04M 1/02

(52) U.S. Cl. CPC H04N 5/23229; H04N 5/23206; H04N 5/23245; H04M 1/0264; H04N 5/93

(57) ABSTRACT

There is provided an imaging device configured to provide an image generated by the imaging device to an information processing device connected utilizing wireless communication. In addition, the information processing device includes a control part. The control part included in the information processing device is configured to perform control of setting, on the basis of the use mode of the information processing device, a reproduction application that reproduces an image generated by the imaging device connected utilizing wireless communication.

### CROSS REFERENCE TO RELATED APPLICATIONS

This application is a U.S. National Phase of International Patent Application No. PCT/JP2015/056291 filed on Mar. 4, 2015, which claims priority benefit of Japanese Patent Application No. JP 2014-126363 filed in the Japan Patent Office on Jun. 19, 2014 The above-referenced applications is hereby incorporated herein by reference in its entirety.

### TECHNICAL FIELD

The present technology relates to an information processing device and an imaging device. In detail, the present technology relates to the information processing device, an imaging device, an imaging system that treats an image generated by imaging operation, and a controlling method thereof, and a program that makes a computer execute the method.

### BACKGROUND ART

An imaging device such as a digital still camera or a digital video camera (for instance, a camera integrated type recorder) that images an object, generates an image (image data) and records the image as contents has been widely spread. Also, there exists a wireless communication technology of exchanging various kinds of data utilizing wireless communication.

Also, there exists a technology of operating an imaging device by another device utilizing wireless communication. For instance, there is proposed an electronic device that, when a contact operation to an operation switch image displayed at a display part is detected, makes an imaging device execute an operation corresponding to the operation switch image on which the contact operation has been performed (for instance, refer to Patent Literature 1).

### CITATION LIST

### Patent Literature

Patent Literature 1: JP 2009-94591A

### SUMMARY OF INVENTION

### Technical Problem

In the above-mentioned related art, since the imaging device is operated by the electronic device utilizing the wireless communication, for instance, even when the imaging device and the electronic device are at a distance, the imaging device is operated using the electronic device.

Here, it is assumed to perform imaging operation, image editing, or the like, using, for instance, an information processing device capable of operating an imaging device utilizing wireless communication. In such a case, it is assumed that what a user intends to do differs depending on the user's use mode of the information processing device and the imaging device. In a case where imaging operation, image editing, or the like is performed by use of an imaging device and an information processing device, it is therefore important to bring about a state of quickly using an appropriate reproduction application according to the use mode thereof.

The present technology, which has been made in view of the aforementioned situation, is directed to quickly using an appropriate reproduction application according to the use mode of devices.

### Solution to Problem

The present technology has been achieved in view of solving the above problem, and a first aspect of the present technology provides an information processing device including a control part configured to perform control of setting, on the basis of a use mode of the information processing device, a reproduction application that reproduces an image generated by an imaging device connected utilizing wireless communication, a method of controlling the information processing device, and a program for causing a computer to execute the method. Accordingly, there is brought about an effect of setting the reproduction application on the basis of the use mode of the information processing device.

Further, in the first aspect, the control part may determine the use mode of the information processing device at a timing when activation of the reproduction application is instructed based on a user's operation, or at a timing when a recording process of the image is performed based on a user's operation, and sets the reproduction application based on the determination result. Accordingly, there is brought about an effect of determining the use mode of the information processing device at a predetermined timing, and setting the reproduction application on the basis of the result of determination.

Further, in the first aspect, the control part may set either a first reproduction application which maintains connection with the imaging device utilizing wireless communication also after activation, or a second reproduction application which disconnects connection with the imaging device utilizing wireless communication after activation. Accordingly, there is brought about an effect of setting either the first reproduction application or the second reproduction application.

Further, in the first aspect, the control part may set the first reproduction application in a case where the imaging device is mounted on the information processing device, or sets the second reproduction application in a case where the imaging device is not mounted on the information processing device. Accordingly, there is brought about an effect of setting the first reproduction application in a case where the imaging device is mounted on the information processing device, or setting the second reproduction application in a case where the imaging device is not mounted on the information processing device.

Further, in the first aspect, the control part may set the first reproduction application in a case where the imaging device and the information processing device are connected utilizing wireless communication, or sets the second reproduction application in a case where the connection between the imaging device and the information processing device utilizing the wireless communication is disconnected. Accordingly, there is brought about an effect of setting the first reproduction application in a case where the imaging device and the information processing device are connected utilizing wireless communication, or setting the second reproduction application in a case where the connection between the imaging device and the information processing device utilizing wireless communication is disconnected.

Further, in the first aspect, the control part may set the first reproduction application in a case where the information processing device is used in a laterally directed state, or sets the second reproduction application in a case where the information processing device is used in a vertically directed state. Accordingly, there is brought about an effect of setting the first reproduction application in a case where the information processing device is used in a laterally directed state, or setting the second reproduction application in a case where the information processing device is used in a vertically directed state.

Further, in the first aspect, the control part may perform control of setting the reproduction application on the basis of a mounting state of the imaging device and the information processing device. Accordingly, there is brought about an effect of setting the reproduction application on the basis of the mounting state of the imaging device and the information processing device.

Further, in the first aspect, the control part may perform control of setting the reproduction application on the basis of a connection state between the imaging device and the information processing device utilizing wireless communication. Accordingly, there is brought about an effect of setting the reproduction application on the basis of the connection state between the imaging device and the information processing device utilizing wireless communication.

Further, in the first aspect, the control part may perform control of setting the reproduction application on the basis of a posture in which the information processing device is used. Accordingly, there is brought about an effect of setting the reproduction application on the basis of the posture in which the information processing device is used.

Still further, a second aspect of the present technology provides an imaging device including a control part configured to perform control of setting, on the basis of a use mode of an information processing device connected utilizing wireless communication, a reproduction application that reproduces an image generated by an imaging operation to the information processing device, a method of controlling the imaging device and a program for causing a computer to execute the method. Accordingly, there is brought about an effect of setting the reproduction application in the information processing device on the basis of the use mode of the information processing device.

Still further, a third aspect of the present technology provides an imaging system including an imaging device configured to provide an image generated by an imaging operation to an information processing device connected utilizing wireless communication, and an information processing device configured to perform control of setting, on the basis of a use mode of the information processing device, a reproduction application which reproduces an image provided from the imaging device, a method of controlling the imaging system, and a program for causing a computer to execute the method. Accordingly, there is brought about an effect of setting the reproduction application on the basis of the use mode of the information processing device.

### Advantageous Effects of Invention

According to the present technology, there may be exhibited a superior effect that allows for quick use of an appropriate reproduction application according to the use mode of the device. Note that the effect described here is not necessarily limited to the foregoing and may be any of the effects described in the present disclosure.

### BRIEF DESCRIPTION OF DRAWINGS

FIG. 1 is a diagram illustrating an appearance configuration of an imaging device 100 in a first embodiment of the present technology.

FIG. 2 is a diagram illustrating an appearance configuration when attaching the imaging device 100 to an information processing device 200 in the first embodiment of the present technology.

FIG. 3 is a block diagram illustrating a functional configuration example of the imaging device 100 and the information processing device 200 in the first embodiment of the present technology.

FIG. 4 is a diagram illustrating a use example of the imaging device 100 and the information processing device 200 in the first embodiment of the present technology.

FIG. 5 is a diagram illustrating a display example of a display screen displayed on an input/output part 240 in the first embodiment of the present technology.

FIG. 6 is a diagram illustrating a display example of a display screen displayed on an input/output part 240 in the first embodiment of the present technology.

FIG. 7 is a diagram illustrating a display example of a display screen displayed on an input/output part 240 in the first embodiment of the present technology.

FIG. 8 is a diagram illustrating a display example of a display screen displayed on an input/output part 240 in the first embodiment of the present technology.

FIG. 9 is a diagram illustrating a display example of a display screen displayed on an input/output part 240 in the first embodiment of the present technology.

FIG. 10 is a flowchart illustrating one example of a processing procedure of a reproduction application setting process performed by an information processing device 200 according to the first embodiment of the present technology.

FIG. 11 is a flowchart illustrating one example of a processing procedure of a reproduction application setting process performed by an information processing device 200 according to the second embodiment of the present technology.

FIG. 12 is a flowchart illustrating one example of a processing procedure of a reproduction application setting process performed by an information processing device 200 according to the third embodiment of the present technology.

FIG. 13 is a flowchart illustrating one example of a processing procedure of a reproduction application setting process performed by an information processing device 200 according to the third embodiment of the present technology.

### DESCRIPTION OF EMBODIMENT(S)

In the following, forms for implementing the present technology (referred to as embodiments, in the following) will be described. Description will be provided in the following order.

1. First embodiment (an example of setting a reproduction application on the basis of the mounting state of an imaging device and an information processing device)

2. Second embodiment (an example of setting a reproduction application on the basis of the existence or absence of an imaging device connectable utilizing wireless communication)

3. Third embodiment (an example of setting a reproduction application on the basis of the posture of the information processing device)

### 1. First Embodiment

### [Appearance Configuration Example of Imaging Device]

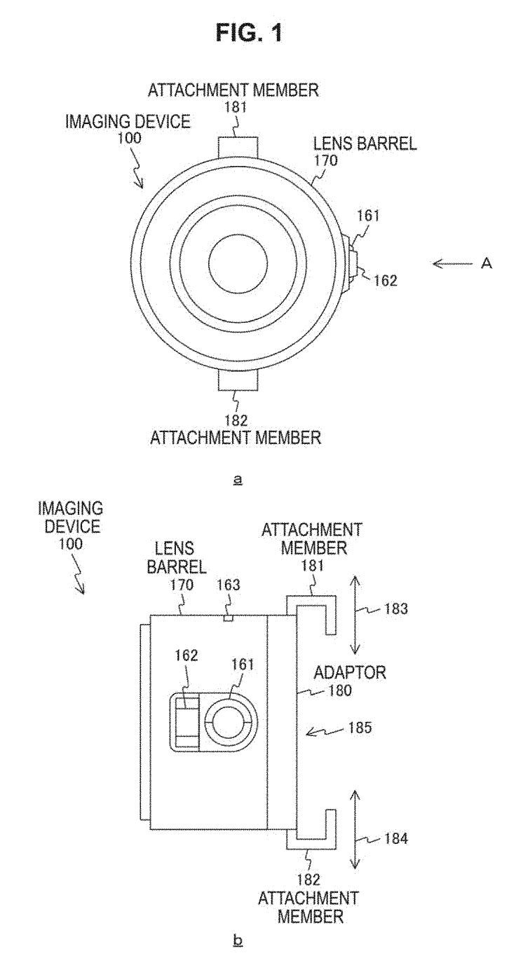

FIG. 1 is a diagram illustrating an appearance configuration of an imaging device 100 in the first embodiment of the present technology. A front view of the imaging device 100 is illustrated in FIG. 1a, and a side view (a side view in the case of view from an arrow A) of the imaging device 100 is illustrated in FIG. 1b.

Also, in the embodiment of the present technology, an example is illustrated in which the imaging device 100 is a cylindrical (columnar) imaging device (for instance, a lens style camera). That is, an example is illustrated in which the shape of the imaging device 100 is a shape of a lens part alone taken out of a general imaging device (for instance, an incorporated type camera). The imaging device 100 includes operation members such as a zoom lever and a shutter button; however, illustrations thereof are omitted in FIG. 1 or the like. Also, the imaging device 100 is, for instance, embodied by a digital still camera or a digital video camera (for instance, a camera incorporated type recorder).

The imaging device 100 includes operation members 161 to 163 and a lens barrel 170. The lens barrel 170 accommodates respective members such as an optical system and an imaging system.

In addition, the imaging device 100 has an adaptor 180 attached thereto. The adaptor 180, including attachment members 181 and 182, is an attachment member (attachment) which is attachable and detachable to and from the rear side (the side opposite to the side of the lens illustrated in FIG. 1a) of the imaging device 100. Note that, although FIG. 1 illustrates an example of forming the lens barrel 170 and the adaptor 180 as different members, the lens barrel 170 and the adaptor 180 may be integrally formed.

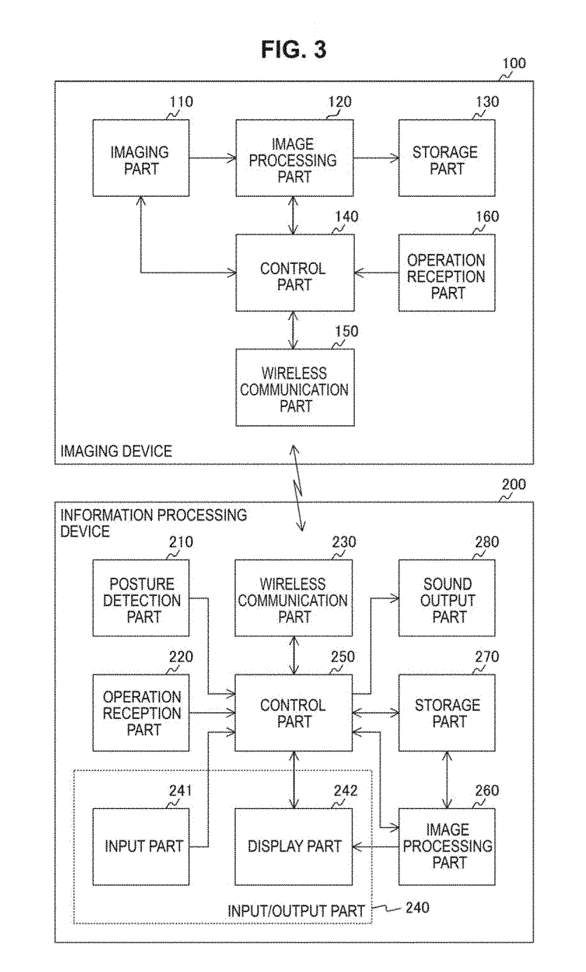

The operation members 161 to 163 are used when performing various input operations. For instance, the operation member 161 is an operation member (shutter button) used when performing a shutter operation (operation for recording an image (image data) generated by the imaging part 110 (illustrated in FIG. 3) as image contents) of the imaging device 100. In addition, the operation member 162 is an operation member (zoom lever) used when performing a zooming operation of the imaging device 100. In addition, the operation member 163 is an operation member (power button) used for performing an ON/OFF operation of the power source of the imaging device 100.

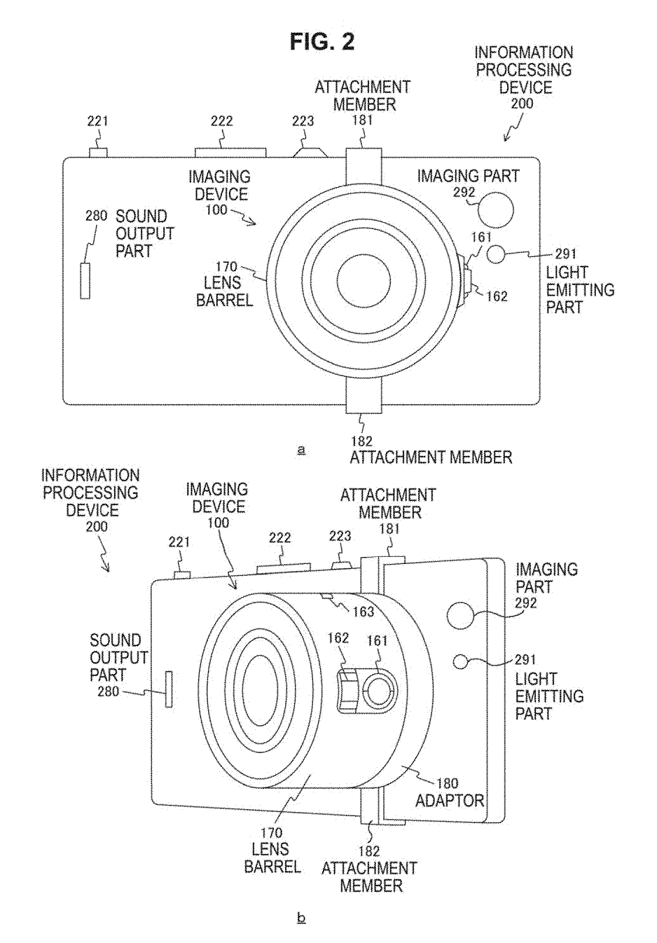

The attachment members 181 and 182 are sandwiching members used when attaching the imaging device 100 to another device (e.g., information processing device 200 illustrated in FIG. 2). For instance, the imaging device 100 can be attached to the device by moving the attachment member 181 in the direction of an arrow 183 and moving the attachment member 182 in the direction of an arrow 184, according to the shape and size of the other device. In other words, the attachment members 181 and 182 are sandwiching members for fixing the imaging device 100 to another device. In addition, an attachment face when mounting the imaging device 100 to another device is illustrated as a mounting surface 185 (a side opposite to the side of the lens illustrated in FIG. la). Note that an example of attaching the imaging device 100 to another device is illustrated in FIG. 2.

In this way, the imaging device 100 can, for instance, perform a normal imaging operation and be mounted on another device (for instance, a smartphone) and used. Also, in the case of being mounted on another device and used, the imaging device 100 can be operated by remote control using another device.

### [Attachment Example of Imaging Device]

FIG. 2 is a diagram illustrating an appearance configuration in the case of attaching the imaging device 100 to the information processing device 200 in the first embodiment of the present technology.

An example of the case of attaching the imaging device 100 to one surface (a surface provided with an imaging part 292) of the information processing device 200 is illustrated in FIG. 2a and FIG. 2b. In FIG. 2a, a front view in the case of attaching the imaging device 100 to the information processing device 200 is illustrated. Also, in FIG. 2b, a perspective view in the case of attaching the imaging device 100 to the information processing device 200 is illustrated.

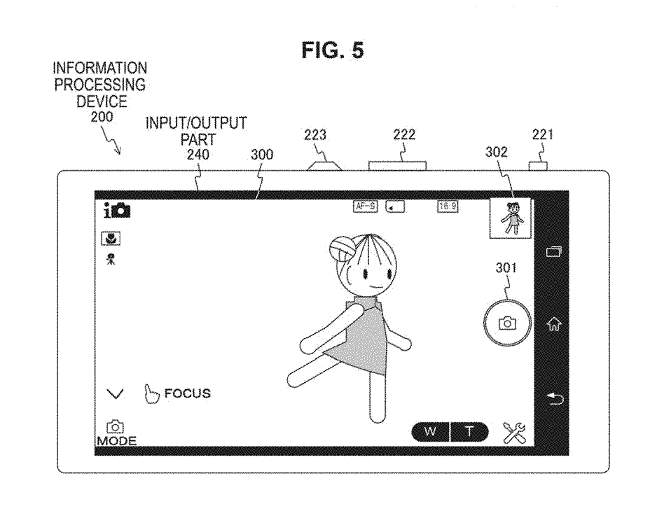

The information processing device 200 includes operation members 221 to 223, an input/output part 240 (illustrated in FIG. 3, FIG. 5, and the like), a sound output part 280, a light emitting part 291, and the imaging part 292. Also, the information processing device 200 is embodied by an information processing device such as a smartphone, or a tablet terminal, for instance.

The operation members 221-223 are the operation members used when performing various kinds of operation input. For instance, the operation member 221 is the operation member (the shutter button) used when performing a shutter operation (an operation for recording an image (image data) generated by the imaging part 292 as image contents) of the information processing device 200. Also, the operation member 222 is the operation member (a sound volume adjustment button (a sound volume bar)) used when performing an operation for adjusting a sound volume output from the sound output part 280. The operation member 223 is the operation member (the power button) used when performing ON/OFF operations of a power source of the information processing device 200.

The input/output part 240 displays various kinds of images, and receives the operation input from a user on the basis of the detected state of an object which is adjacent to or in contact with a display surface of the input/output part 240.

The sound output part 280 outputs various kinds of sound information.

The light emitting part 291 is a light emitting device which emits light to an object. The light emitting part 291 is used when performing an imaging operation using the information processing device 200 in an environment where it is difficult to expect sufficient brightness such as the nighttime or indoor, for instance.

The imaging part 292 images an object and generates an image (image data).

As illustrated in FIG. 2, by the attachment members 181 and 182 of the adaptor 180 holding a main body of the information processing device 200 between them, the imaging device 100 can be fixed to the information processing device 200. Also, the imaging device 100 may be attached to another part (a part other than the part illustrated in FIG. 2) in the information processing device 200.

### [Functional Configuration Example of Imaging Device and Information Processing Device]

FIG. 3 is a block diagram illustrating a functional configuration example of the imaging device 100 and the information processing device 200 in the first embodiment of the present technology. Also, an imaging system constituted of the imaging device 100 and the information processing device 200 is one example of an imaging system described in the scope of claims.

### [Functional Configuration Example of Imaging Device]

The imaging device 100 includes an imaging part 110, an image processing part 120, a storage part 130, a control part 140, a wireless communication part 150, and an operation reception part 160.

The imaging part 110 images an object and generates an image (image data) on the basis of control of the control part 140, and outputs the generated image to the image processing part 120. The imaging part 110 is, for instance, constituted of an optical system (a plurality of lenses) and an imaging element. Also, individual parts (for instance, a zoom lens, a focus lens, a diaphragm) of the imaging part 110 are controlled under the control of the control part 140. In the embodiment of the present technology, it is assumed that a reference to “image” includes senses of both image itself and image data for displaying the image.

The image processing part 120 executes predetermined image processing (for instance, demosaic processing) for the image output from the imaging part 110 under the control of the control part 140, and the image subjected to the image processing is stored in the storage part 130. The image subjected to the image processing by the image processing part 120 may be transmitted to the information processing device 200 utilizing wireless communication and stored in a storage part 270.

The storage part 130 is a recording medium that stores the image subjected to the image processing by the image processing part 120 as contents (for instance, a still image file, a moving image file). The storage part 130 may be built in the imaging device 100 or may be attachable and detachable to/from the imaging device 100.

The control part 140 controls the individual parts in the imaging device 100 on the basis of a control program. For instance, the control part 140 controls the individual parts on the basis of the operation input received by the operation members (the operation reception part 160) such as the zoom lever or the shutter button provided in the imaging device 100. Also, the control part 140 controls the individual parts on the basis of control information from the information processing device 200 received through the wireless communication part 150. That is, the imaging device 100 can be remotely controlled using the information processing device 200.

The wireless communication part 150 transmits and receives individual pieces of information (for instance, control data, image data) to/from another information processing device (for instance, the information processing device 200) utilizing the wireless communication under the control of the control part 140.

Here, as the wireless communication, for instance, a wireless local area network (LAN) may be used. As the wireless LAN, for instance, wireless fidelity (Wi-Fi) may be used. Also, as the wireless communication, for instance, the wireless communication of Bluetooth (R), near field communication (NFC), infrared rays, and portable radio waves or the like may be used.

Also, a plurality of wireless communication systems may be used. For instance, at the start of the wireless communication, only a power source is turned on and data (for instance, a service set identifier (SSID)) related to the Wi-Fi is exchanged by the NFC. Then, data is exchanged thereafter through the Wi-Fi.

Also, for instance, when detecting mounting of the imaging device 100 on the information processing device 200, exchange of data by the NFC may be used. Also, the image data and the control data can be exchanged between the imaging device 100 and the information processing device 200 utilizing the Wi-Fi.

The operation reception part 160 is the operation reception part that receives an operation performed by a user and outputs, to the control part 140, control information (operation information) according to the received content of operation. The operation reception part 160 corresponds to, for instance, the operation members 161 to 163 illustrated in FIG. 1.

### [Functional Configuration Example of Information Processing Device]

The information processing device 200 includes a posture detection part 210, an operation reception part 220, a wireless communication part 230, the input/output part 240, a control part 250, an image processing part 260, the storage part 270, and the sound output part 280.

The posture detection part 210 detects a posture of the information processing device 200 by detecting an acceleration, movement and inclination or the like of the information processing device 200, and outputs posture information related to the detected the posture to the control part 250. As the posture detection part 210, for instance, various kinds of sensors such as a gyro sensor or an acceleration sensor may be used.

The operation reception part 220 is the operation reception part that receives the operation performed by the user, and outputs the control information (operation information) according to the received operation contents to the control part 250. The operation reception part 220 corresponds to, for instance, the operation members 221 to 223 illustrated in FIG. 2.

The wireless communication part 230 transmits and receives individual pieces of information (for instance, the control data, the image data) to/from another information processing device (for instance, the imaging device 100) utilizing the wireless communication under the control of the control part 250. As the wireless communication, for instance, the above described wireless LAN (for instance, the Wi-Fi), the NFC, Bluetooth, infrared rays or portable radio waves or the like may be used. Also, the plurality of wireless communication systems may be used.

For the input/output part 240, an input part 241 and a display part 242 are configured as one body. Also, the input/output part 240 displays various kinds of images on the display part 242 under the control of the control part 250, and receives the operation input from the user by the input part 241 on the basis of the detected state of an object which is adjacent to or in contact with a display surface of the display part 242. The input part 241 outputs the control information according to the received operation input to the control part 250.

For instance, as the input part 241, there may be used an electrostatic type (electrostatic capacity type) touch panel that detects contact or approach of a conductive object (for instance, a finger of a person) on the basis of change in electrostatic capacity. Also, for instance, as the display part 242, there may be used a display panel such as a liquid crystal display (LCD) or an organic electro luminescence (EL) panel. Then, the input/output part 240 is configured by superimposing a transparent touch panel on the display surface of the display panel, for instance.

For instance, the user can operate the information processing device 200 and the imaging device 100 by performing a contact operation (or an adjacent operation) of an operation object or the like displayed at the display part 242. Here, the operation object is displayed at the input/output part 240 like the shutter button 301 and the operation object 302 illustrated in FIG. 5, for instance, and is an operation button (a graphical user interface (GUI) button) or the like for performing the operation input.

The control part 250 controls the individual parts in the information processing device 200 on the basis of a control program. For instance, the control part 250 determines the posture of the information processing device 200 on the basis of the posture information from the posture detection part 210, and switches a display form of the display screen to be displayed at the input/output part 240 based on the determination result. For instance, the control part 250 determines a vertical direction of the posture of the information processing device 200 on the basis of the posture information from the posture detection part 210, and switches the vertical direction of the display screen to be displayed at the input/output part 240 on the basis of the determination result.

In addition, for instance, the control part 250 performs control of setting a reproduction application that reproduces an image generated by an imaging operation by the imaging device 100 connected utilizing wireless communication, on the basis of the use mode of the information processing device 200. Here, the use mode of the information processing device 200 includes, for instance, the mounting state of the imaging device 100 and the information processing device 200, the connection state of the imaging device 100 and the information processing device 200, and the posture of the information processing device 200.

In addition, for instance, the control part 250 determines the use mode of the information processing device 200 at a timing when activation of the reproduction application is instructed on the basis of the user's operation, or at a timing when an image recording process is performed on the basis of the user's operation. The control part 250 then sets the reproduction application on the basis of the result of determination.

In addition, the control part 250 sets either a simplified reproduction application that maintains the connection with the imaging device 100 utilizing wireless communication also after the activation, or a reproduction/edition application that disconnects the connection with the imaging device 100 utilizing the wireless communication after the activation.

In addition, for instance, the control part 250 performs control of setting the reproduction application on the basis of the mounting state of the imaging device 100 and the information processing device 200. In such a case, the control part 250 sets the simplified reproduction application in a case where the imaging device 100 is mounted on the information processing device 200, or sets the reproduction/edition application in a case where the imaging device 100 is not mounted on the information processing device 200.

In addition, for instance, the control part 250 performs control of setting the reproduction application on the basis of the connection state between the imaging device 100 and the information processing device 200 utilizing wireless communication. In such a case, the control part 250 sets the simplified reproduction application in a case where the imaging device 100 and the information processing device 200 are connected the utilizing wireless communication. On the other hand, the control part 250 sets the reproduction/edition application in a case where the connection between the imaging device 100 the information processing device 200 utilizing the wireless communication is disconnected. Note that the present example is illustrated in the second embodiment of the present technology.

In addition, for instance, the control part 250 performs control of setting the reproduction application on the basis of the posture in which the information processing device 200 is used. In such a case, the control part 250 sets the simplified reproduction application when the information processing device 200 is used in a laterally directed state, or sets the reproduction/edition application in a case where the information processing device 200 is used in a vertically directed state. Note that the present example is illustrated in the third embodiment of the present technology.

The image processing part 260 executes predetermined image processing for the image generated by the imaging device 100 and the image generated by the imaging part 292 (illustrated in FIG. 2a and FIG. 2b) under the control of the control part 250, and makes the display part 242 display the image subjected to the image processing. Also, the image processing part 260 stores the images in the storage part 270 under the control of the control part 250. Also, the image processing part 260 makes the display part 242 display the display screen to be used when the imaging operation using the imaging device 100 is being performed, under the control of the control part 250.

The storage part 270 is a recording medium that stores individual pieces of information under the control of the control part 250. For instance, in the storage part 270, the image generated by the imaging device 100 and the image generated by the imaging part 292 (illustrated in FIG. 2a and FIG. 2b) are stored as contents (for instance, the still image file, the moving image file). The storage part 270 may be built in the information processing device 200 or may be attachable and detachable to/from the information processing device 200.

The sound output part 280 outputs sound information under the control of the control part 250. The sound output part 280 can be embodied by a speaker, for instance.

### [Use Example of Imaging Device and Information Processing Device]

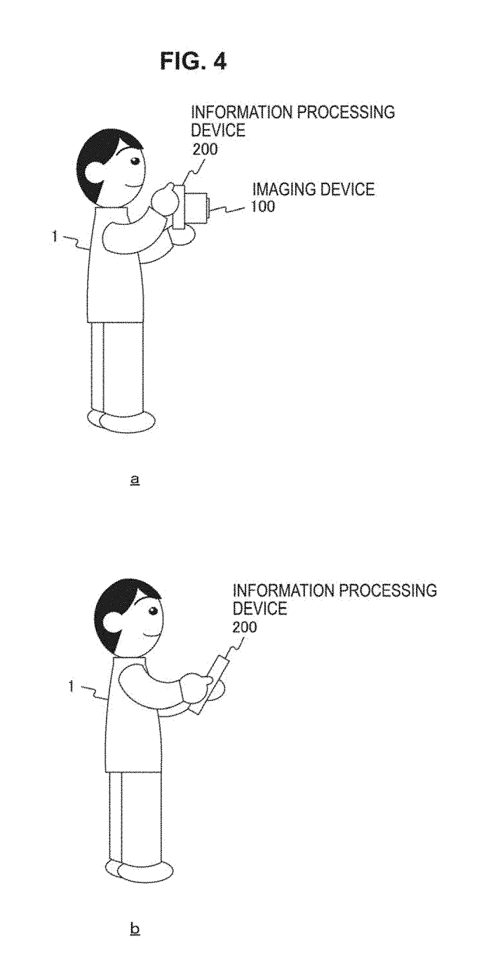

FIG. 4 is a diagram illustrating a use example of the imaging device 100 and the information processing device 200 in the first embodiment of the present technology.

In FIG. 4a, one example in the case of using the imaging device 100 mounted on the information processing device 200 is illustrated. For instance, as illustrated in FIGS. 2a and 2b, the imaging device 100 can be mounted on one surface (a surface opposite to the surface having the input/output part 240 provided thereon) of the information processing device 200. In this case, the user 1 can take a photograph in substantially a similar way as in the case of taking a photograph with a general imaging device (for instance, an incorporated type camera) by using the information processing device 200 having the imaging device 100 mounted thereon. For instance, the user 1 may use the information processing device 200 in a laterally directed state.

Here, it is assumed that the laterally directed state refers to a state in which the longitudinal direction of the information processing device 200 is defined to be identical (including a substantially identical state, which is close to the horizontal direction) to the horizontal direction (a direction perpendicular to the gravity direction). For instance, the states are the states illustrated in FIGS. 2a and 2b.

FIG. 4b illustrates an exemplary case where only the information processing device 200 is used without the imaging device 100 mounted thereon. For instance, the user 1 may use the information processing device 200 in a vertically directed state.

Here, it is assumed that the vertically directed state refers to a state in which the longitudinal direction of the information processing device 200 is defined to be identical (including a substantially identical state, which is close to the vertical direction) to the vertical direction (a direction parallel to the gravity direction). For instance, it is possible to set the information processing device 200 in the vertically directed state by rotating the information processing device 200 in the laterally directed state by 90 degrees about an axis perpendicular to the display surface of the input/output part 240. Similarly, it is possible to set the information processing device 200 in the laterally directed state by rotating the information processing device 200 in the vertically directed state by 90 degrees about axis perpendicular to the display surface of the input/output part 240. In addition, the laterally directed state and the vertically directed state can be determined on the basis of posture information from the posture detection part 210.

### [Example of Determining Connection Relation Between Imaging Device and Information Processing Device]

Here, a method of determining connection relation between the imaging device 100 and the information processing device 200 will be described.

### [Example of Estimating Distance Using Reception Radio Field Intensity]

For instance, a distance between the imaging device 100 and the information processing device 200 can be estimated using reception radio field intensity. For instance, a table indicating relationship between the reception radio field intensity and the distance is prepared, and stored in the storage part 270. Then, the control part 250 of the information processing device 200 acquires the distance corresponding to the reception radio field intensity acquired by the wireless communication part 230 from the table, and can use the distance as the distance between the imaging device 100 and the information processing device 200. Also, when the distance acquired from the table is shorter than a threshold (for instance, 1 to 10 cm), the control part 250 of the information processing device 200 can determine that the imaging device 100 is mounted on the information processing device 200.

### [Example of Using Member for Detecting Mounting]

For instance, mounting of the imaging device 100 can be detected using a member for detecting that the imaging device 100 is mounted on the information processing device 200. As the member, for instance, a switch can be provided on at least one of the imaging device 100 and the information processing device 200.

For instance, the case of providing the switch on the imaging device 100 is assumed. In this case, when the imaging device 100 is mounted on the information processing device 200, the mounting is detected by the switch, and information indicating that the mounting is detected is output to the control part 140. Then, when the information indicating that the mounting is detected is acquired, the control part 140 transmits that effect to the information processing device 200 through the wireless communication part 150. Thus, the control part 250 of the information processing device 200 can detect that the imaging device 100 is mounted on the information processing device 200.

Also, for instance, the case of providing the switch on the information processing device 200 is assumed. In this case, when the imaging device 100 is mounted on the information processing device 200, the mounting is detected by the switch, and the information indicating that the mounting is detected is output to the control part 250. Thus, the control part 250 of the information processing device 200 can detect that the imaging device 100 is mounted on the information processing device 200.

Also, the distance between the imaging device 100 and the information processing device 200 may be detected using another sensor. For instance, a distance sensor (for instance, a sensor which detects the distance using infrared rays or ultrasonic waves) may be used. Also, for instance, the distance between the imaging device 100 and the information processing device 200 may be detected using a global positioning system (GPS). For instance, respective positions of the imaging device 100 and the information processing device 200 are acquired using the GPS, and the distance between the imaging device 100 and the information processing device 200 can be calculated on the basis of these positions. Also, when the calculated distance is shorter than the threshold (for instance, 1 to 10 cm), the control part 250 of the information processing device 200 can determine that the imaging device 100 is mounted on the information processing device 200.

### [Example of Detecting Mounting of Imaging Device Using Short-Range Wireless Communication]

For instance, mounting of the imaging device 100 with the information processing device 200 can be detected using short-range wireless communication. Here, an example of using NFC as the short-range wireless communication is illustrated.

For instance, in the NFC, periodical communication is performed between the devices. For instance, a polling command is issued periodically from the information processing device 200. The polling command is a command for discriminating an NFC tag determined by an NFC standard (for instance, see NFC Forum Type3 Tag Operation Specification NFC Forum-TS-Type-3-Tag_1.1).

For instance, when there is a response (polling response) to the periodically issued polling command, the information processing device 200 can determine that an adjacent device exists. Here, a distance at which data communication utilizing the NFC is possible is about 1 to 10 cm. Accordingly, when there is the polling response, the control part 250 of the information processing device 200 can determine that the imaging device 100 is mounted on the information processing device 200.

Also, when there is no response (polling response) to the polling command, the information processing device 200 can determine that an adjacent device does not exist. In this case, the control part 250 of the information processing device 200 can determine that the imaging device 100 is not mounted on the information processing device 200.

Here, the NFC is widely spread. Also, the NFC is often loaded on an information processing device such as a smartphone. Therefore, in the case of the information processing device loaded with the NFC, by detecting the mounting using the NFC, hardware may not necessarily be newly provided for performing the detection. Thus, a manufacturing cost of the information processing device can be reduced.

Here, for instance, it is also assumed that the imaging device is not mounted on the information processing device and the imaging device and the information processing device are adjacent. In such a case, when mounting is detected using the short-range wireless communication other than the NFC, there is a risk of erroneous detection that the imaging device is mounted, however, by using the NFC as the short-range wireless communication, accuracy of detecting mounting of the imaging device can be improved.

### [Example of Detecting Mounting of Imaging Device Using Check Command and Check Response]

The example of detecting mounting of the imaging device using the NFC is illustrated above. When detecting mounting of the imaging device using the NFC in this way, mounting of the imaging device may be detected using a check command and a check response.

For instance, the check command and the check response are exchanged, and when specifying information is included in the check response, it can be determined that the imaging device 100 is mounted on the information processing device 200. Here, the specifying information is information (identification information) for specifying the imaging device 100. Also, the check command and the check response are commands for reading contents of an NFC tag. The command is defined in NFC Forum Type3 Tag Operation Specification.

For instance, as described above, the polling command is issued and a response (polling response) to the polling command is exchanged.

Then, when the polling response is received, the control part 250 of the information processing device 200 transmits the check command. When the check command is received, the control part 140 of the imaging device 100 transmits a response (check response) to the check command. In this case, the control part 140 of the imaging device 100 includes the specifying information (the information (identification information) for specifying the imaging device 100) in the check response and transmits it.

For instance, information indicating “ABC DSC/Lens-Style Camera” can be included in the check response and transmitted as the specifying information. Here, for instance, it is assumed that “ABC” is information indicating a name of a company which manufactures the imaging device 100, and “DSC” is information indicating that it is the imaging device. Also, it is assumed that “Lens-Style Camera” is information indicating that it is a lens style camera.

In this way, the control part 140 of the imaging device 100 includes the specifying information in the check response and transmits it. Thus, the information processing device 200 which receives the check response can recognize that the device which has transmitted the check response is the imaging device 100 on the basis of the specifying information included in the check response. That is, it can be recognized that the device which has transmitted the check response is the lens style camera (the imaging device 100) made by the company “ABC”.

When the check response is received, the control part 250 of the information processing device 200 acquires contents of the check response. Subsequently, the control part 250 of the information processing device 200 determines whether or not the specifying information is included in the check response. Then, when the specifying information is included in the check response, the control part 250 of the information processing device 200 determines that the imaging device 100 is mounted on the information processing device 200. On the other hand, when the specifying information is not included in the check response, the control part 250 of the information processing device 200 determines that the imaging device 100 is not mounted on the information processing device 200.

Note that, although this example describes a case of detecting, by the information processing device 200, mounting of the imaging device 100 using an NFC, the present technology is similarly applicable to a case of detecting, by the imaging device 100, mounting of the information processing device 200 using an NFC.

The above-described distance detection method and mounting detection method are examples, and other detection methods may be used without being limited to these methods.

### [Example of Reproduction Application]

The embodiment of the present technology describes an example of setting two types of reproduction application (Viewer) as a reproduction application for making the input/output part 240 display (browse) an image generated by the imaging part 110. Specifically, an example of setting a reproduction/edition application (reproduction/edition Viewer) and a simplified reproduction application (simplified Viewer) is described as the two types of reproduction application (Viewer).

The reproduction/edition application is, for instance, a Viewer (full-fledged Viewer) dedicated for reproduction of images (e.g., still image, animation), or a reproduction application specific for editing functions. The reproduction/edition application is, for instance, a reproduction application (e.g., gallery application) preinstalled to the information processing device 200 (e.g., smartphone), or a reproduction application optionally downloaded by the user.

In addition, the reproduction/edition application is provided with an abundance of cooperative functions to social networking service (SNS) applications, and photograph editing functions. In addition, a user-friendly reproduction/edition application may be selected.

However, while the reproduction/edition application is running, the information processing device 200 is connected to the network (e.g., connected via an access point) so as to allow immediate uploading to the SNS or the like. Accordingly, the connection between the information processing device 200 and the imaging device 100 utilizing wireless communication (e.g., Wi-Fi connection) is disconnected while the reproduction/edition application is running.

The simplified application, which is for instance a Viewer provided by a remote-controller application of the imaging device 100 (e.g., remote-controller-attached Viewer), is reproduction application mainly for checking after completion of an imaging operation performed by the imaging part 110. Here, the connection between the information processing device 200 and the imaging device 100 utilizing wireless communication (e.g., Wi-Fi connection) is maintained while the simplified application is running. Accordingly, the information processing device 200 is not connected to the network. However, immediate uploading to the SNS or the like is impossible while the simplified application is running.

For instance, after the user 1 has completed an imaging operation using the imaging device 100 and the information processing device 200, it is assumed that a Viewer which the user desires to use may differ depending on the use mode or environment thereof Therefore, the embodiment of the present technology describes an example of setting an appropriate reproduction application according to the use mode of the device.

### [Display Example on Display Screen]

FIGS. 5 to 9 are diagrams illustrating a display example of a display screen displayed on the input/output part 240 in the first embodiment of the present technology.

FIG. 5 illustrates a display example of displaying an image generated by an imaging operation using the imaging device 100 and the information processing device 200 on the input/output part 240 as a post-view image.

For instance, when an imaging operation (for instance, an imaging operation of a still image file) using the imaging device 100 and the information processing device 200 is performed, an image generated by the imaging part 110 of the imaging device 100 is displayed at the input/output part 240 as a live view image. That is, images generated by the imaging part 110 of the imaging device 100 are sequentially transmitted to the information processing device 200 through the wireless communication parts 150 and 230, and are displayed at the input/output part 240 as a live view image. Also, image data and control data can be exchanged between the imaging device 100 and the information processing device 200 utilizing the Wi-Fi.

As has been thus described, when a user presses the shutter button 301 while a live-view image is being displayed on the input/output part 240, a recording process of the image generated by the imaging part 110 is performed at the timing of the pressing. Subsequently, as illustrated in FIG. 5, an image to be recorded is displayed on the input/output part 240 as a post-view image 300.

Note that the user may press the shutter button (the operation member 161) of the imaging device 100 to instruct recording of the image. In such a case, the recording process of the image generated by the imaging part 110 is performed at the timing of the pressing. In addition, a notification that the pressing has been performed, and a notification that the pressing has triggered the recording process of the image are transmitted from the imaging device 100 to the information processing device 200 at the timing of the pressing.

In addition, when the user's operation is not performed within a predetermined time (e.g., a few seconds) after the post-view image 300 has been displayed, a live-view image is displayed on the input/output part 240. In other words, when the user's operation is not performed within a predetermined time (e.g., a few seconds) after the post-view image 300 has been displayed, the mode of the post-view image returns to the shooting mode from the display mode.

In addition, after the return to the shooting mode, the cycle of display live-view image→press shutter button→display post-view image (a few seconds)→display live-view image (return to shooting mode) . . . is repeatedly performed.

Here, operation objects (including the shutter button 301) for performing individual operations related to imaging operation using the imaging device 100 and the information processing device 200 are displayed on the input/output part 240, together with the display of the post-view image 300. The operation objects are displayed on the input/output part 240 in a manner placed around, or superimposed on, the post-view image 300, for instance.

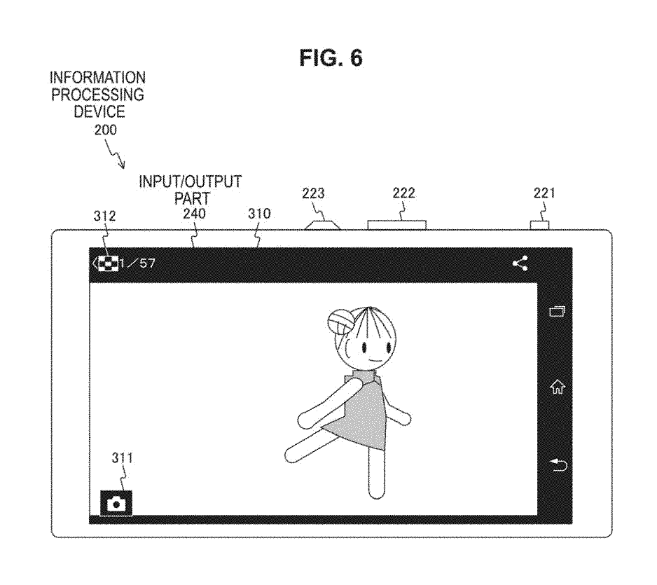

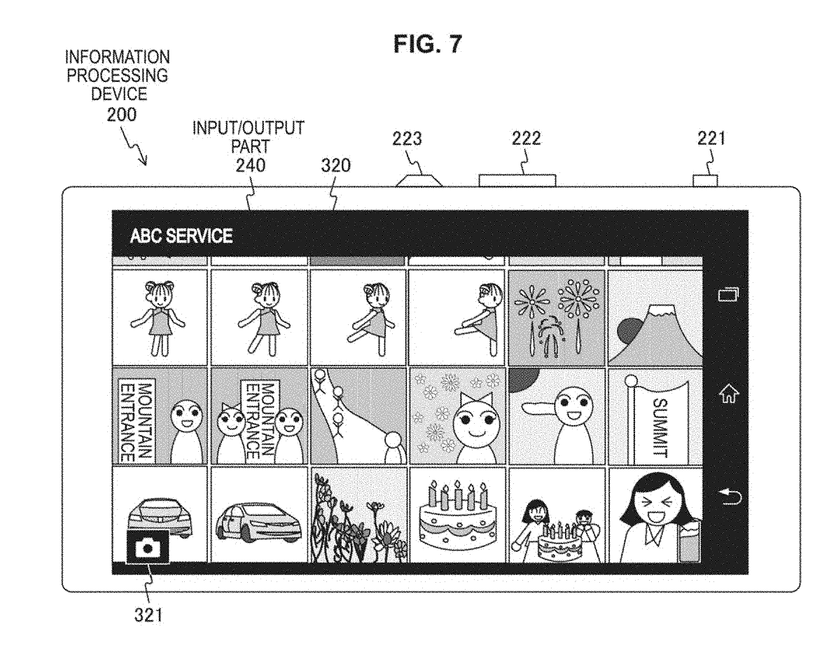

In addition, the operation object 302 for transitioning to the simplified Viewer is displayed together with the display of the post-view image 300. FIG. 5 illustrates an example of displaying, as the operation object 302, an image that is recorded immediately before. When, for instance, the user presses the operation object 302 within a predetermined time (e.g., a few seconds) after the post-view image 300 has been displayed, the mode transitions to the simplified Viewer from the display mode of the post-view image 300. FIGS. 6 and 7 illustrate a display example after the transition.

FIGS. 6 and 7 illustrate a display example of the display screen displayed on the input/output part 240 while the simplified reproduction application (simplified Viewer) is running.

FIG. 6 illustrates an example of the simplified Viewer (display screen 310) displayed when the operation object 302 illustrated in FIG. 5 is pressed. Note that, when the operation object 302 is pressed, the same image is displayed as the post-view image 300 displayed on the input/output part 240 at the timing of the pressing of the operation object 302.

In addition, the operation objects 311 and 312 are displayed on the display screen 310. The operation object 311 is an operation object to be pressed in case of returning to the shooting mode (display mode of the live-view image). In addition, the operation object 312 is an operation object to be pressed in case of displaying a list of images. FIG. 7 illustrates a display example after the pressing.

FIG. 7 displays an example of the simplified Viewer (display screen 320) to be displayed when the operation object 312 illustrated in FIG. 6 is pressed. For instance, a list of images which can be displayed while the simplified Viewer is running is displayed on the display screen 320. In addition, the operation object 321 is displayed on the display screen 320. The operation object 321 is an operation object to be pressed in case of returning to the shooting mode (display mode of the live-view image).

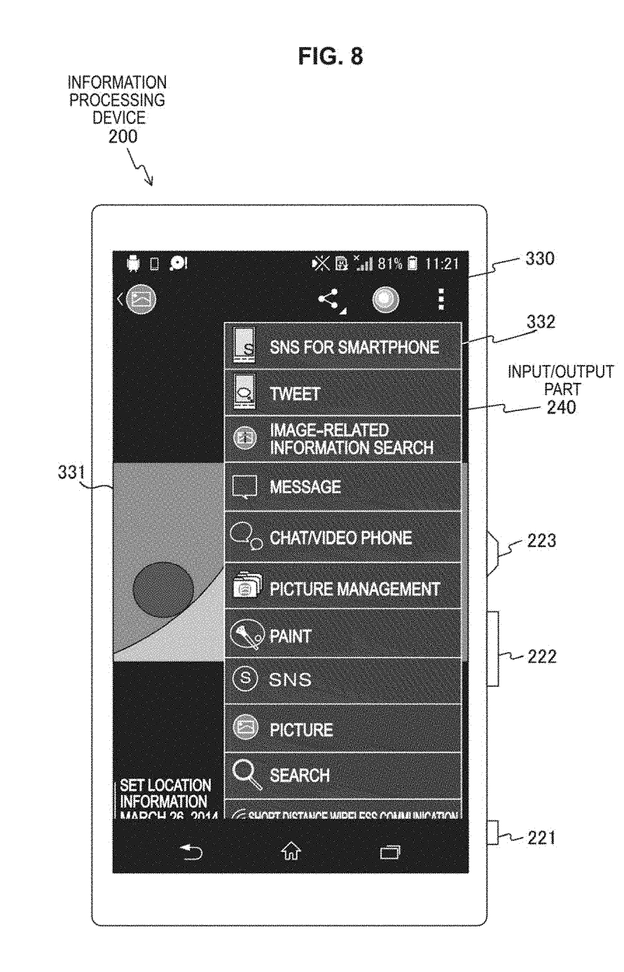

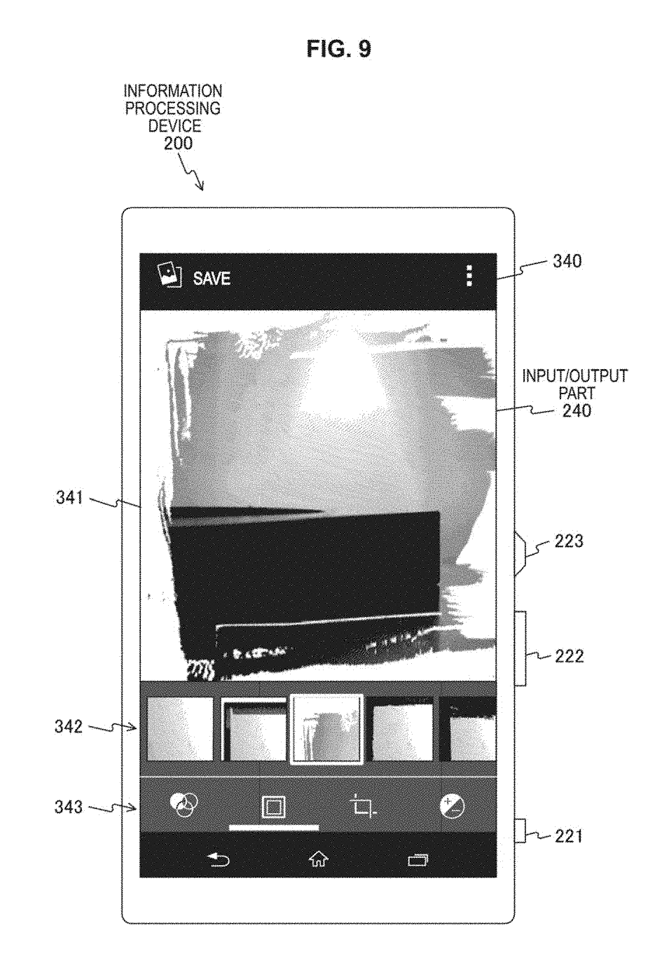

FIGS. 8 and 9 illustrate a display example of the display screen displayed on the input/output part 240 while the reproduction/edition Viewer is running.

FIG. 8 illustrates an example of a display screen (display screen 330) for performing an operation to upload the image 331 via a network while the reproduction/edition Viewer is running. For instance, a user may perform desirable upload for the image 331 by selecting, from operation objects 332, an item for which the image 331 needs to be uploaded, on the display screen 330.

FIG. 9 illustrates an example of a display screen (display screen 340) for performing an operation to perform predetermined editing (rendering) on the image 341, while the reproduction/edition Viewer is running. For instance, a user may perform desirable editing for the image 341 by selecting, from operation objects 342, the content of editing to be performed on the image 341 and performing the editing on the image 341, on the display screen 340. For instance, it is possible to perform an editing so as to paint the periphery of the image 341 with a predetermined color.

### [Example of Setting Reproduction Application]

First, an example of automatically setting (switching to) the reproduction application (Viewer), on the basis of the mounting state (attachment state) of the imaging device 100 and the information processing device 200, will be described.

For instance, let us assume a case where the imaging device 100 is mounted on the information processing device 200. For instance, there is assumed a case where the imaging device 100 is mounted on the information processing device 200 and used, as illustrated in FIG. 4a. In such a case, it is very likely that the imaging operation (e.g., imaging operation of still images, imaging operation of animations) is continuously performed. Accordingly, it is very likely that a quick return to shooting is desired after an image has been checked with the Viewer.

Therefore, in a case where the imaging device 100 is mounted on the information processing device 200, the simplified reproduction application (simplified Viewer) is supposed to be activated, which maintains the connection between the imaging device 100 and the information processing device 200 utilizing wireless communication. Accordingly, after having checked an image with the simplified Viewer, the user can immediately return to the shooting.

On the other hand, for instance, let us assume a case where the imaging device 100 is not mounted on the information processing device 200. For instance, there is assumed a case where the user is using only the information processing device 200, as illustrated in FIG. 4b. In such a case, it is unlikely that imaging operation (e.g., imaging operation of still images, imaging operation of animations) is continuously performed. Accordingly, it is very likely that a quick return to shooting is not desired after the image has been checked with the Viewer. In addition, it is very likely that uploading of the image is desired.

Therefore, in a case where the imaging device 100 is not mounted on the information processing device 200, the reproduction/edition application (reproduction/edition Viewer) is supposed to be activated, which disconnects the connection between the imaging device 100 and the information processing device 200 utilizing wireless communication. Accordingly, after having checked an image with the reproduction/edition Viewer, the user can immediately upload the image.

Here, the timing of determining whether or not to automatically set the reproduction application may be, for instance, a timing at which activation of the reproduction application is instructed by the user's operation, or a timing immediately after having performed the image recording process. In addition, for instance, the timing may be a timing at which the mounting state of the imaging device 100 and the information processing device 200 has changed.

Note that, in a case where it is determined to automatically set (switch to) the reproduction application at a timing when the mounting state of the imaging device 100 and the information processing device 200 has changed, a notification may be sent to the user to confirm whether or not to switch the running Viewer.

### [Operation Example of Information Processing Device]

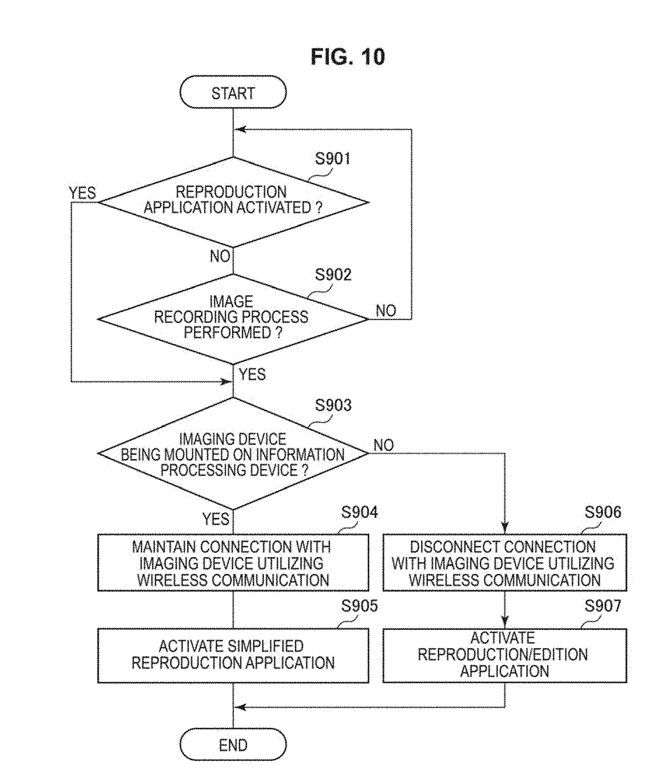

FIG. 10 is a flowchart illustrating one example of a processing procedure of the reproduction application setting process performed by the information processing device 200 according to the first embodiment of the present technology. FIG. 10 illustrates an example of setting the reproduction application at a timing when activation of the reproduction application is instructed by the user's operation, or a timing immediately after having performed the image recording process.

First, the control part 250 determines whether or not activation of the reproduction application (Viewer) has been instructed in the information processing device 200 (step S901). For instance, it is determined whether or not activation of the reproduction application (Viewer) has been instructed automatically, or by the user's operation (step S901).

In a case where activation of the reproduction application has been instructed (step S901), the process flow proceeds to step S903. On the other hand, in a case where activation of the reproduction application has not been instructed (step S901), the control part 250 determines whether or not the image recording process has been performed (step S902). The recording process is performed when, for instance, the user's operation (e.g., pressing operation of the shutter button) for recording a still image (a single still image, still images in continuous shooting) is accepted. In addition, the recording process is performed, when, for instance, the user's operation (e.g., pressing operation of the recording button) for recording animations is accepted. In a case where the image recording process has not been performed (step S902), the process flow returns to step S901.

In a case where the image recording process has been performed (step S902), the control part 250 determines whether or not the imaging device 100 is mounted on the information processing device 200 (step S903). In a case where the imaging device 100 is mounted on the information processing device 200 (step S903), the control part 250 maintains the connection with the imaging device 100 utilizing wireless communication (step S904).

Subsequently, the control part 250 activates the simplified reproduction application (step S905). Note that, in a case where the reproduction/edition application has been activated, switching from the reproduction/edition application to the simplified reproduction application is performed.

Additionally, in a case where the imaging device 100 is not mounted on the information processing device 200 (step S903), the control part 250 disconnects the connection with the imaging device 100 utilizing wireless communication (step S906).

Subsequently, the control part 250 activates the reproduction/edition application (step S907). Note that, in a case where the reproduction application has been activated, switching from the simplified reproduction application to the reproduction/edition application is performed. Note that steps S903 to S907 are an example of the control procedure according to the claims.

### 2. Second Embodiment

For instance, there may also be assumed a case where no imaging device exists near the information processing device, or a case where the power source of the imaging device is turned off. In such a case, the information processing device cannot perform connection with the imaging device utilizing wireless communication and therefore it is unlikely that the user of the information processing device performs an imaging operation using the imaging device.

Therefore, a second embodiment of the present technology describes an example of setting (switching to) the reproduction application on the basis of the existence or absence of a connectable imaging device utilizing wireless communication. The configuration of the imaging device and the information processing device in the second embodiment of the present technology is identical to the configuration of the imaging device 100 and the information processing device 200 illustrated in FIGS. 1 to 3. Accordingly, respective devices in the second embodiment of the present are technology designated by reference signs identical to those in the first embodiment of the present technology, and the description thereof is partially omitted.

### [Operation Example of Information Processing Device]

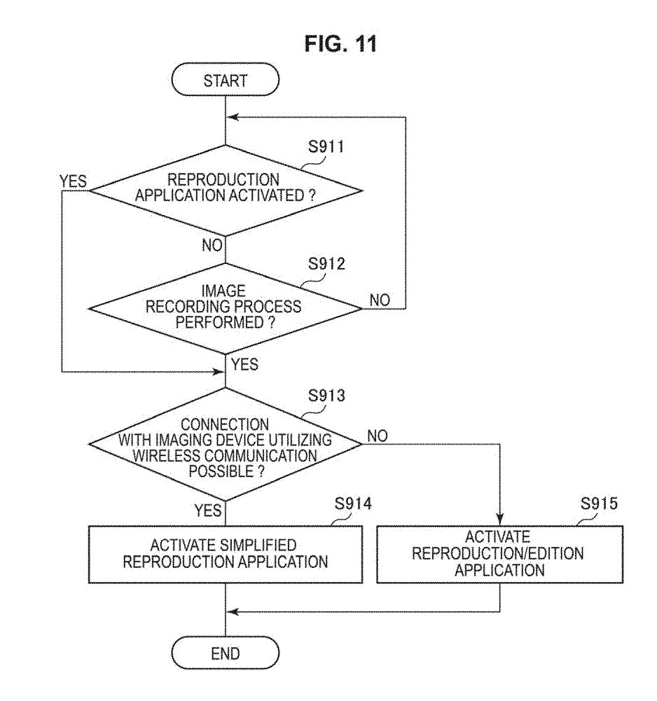

FIG. 11 is a flowchart illustrating one example of a processing procedure of the reproduction application setting process performed by the information processing device 200 according to the second embodiment of the present technology. FIG. 11 illustrates, similarly to FIG. 10, an example of setting the reproduction application at a timing when activation of the reproduction application is instructed by the user's operation, or at a timing immediately after the image recording process is performed. Note that, since steps S911, S912, S914 and S915 correspond to S901, S902, S905 and S907 described in FIG. 10, detailed description thereof is omitted here.

In a case where activation of the reproduction application has been instructed (step S911), or the image recording process has been performed (step S912), the control part 250 determines whether or not connection with the imaging device 100 utilizing wireless communication is possible (step S913).

For instance, in a case of using a wireless LAN (e.g., Wi-Fi) as the wireless communication, the control part 250 searches for the communication state of the wireless LAN and determines whether or not a preliminarily registered device (the imaging device 100) is found. In addition, for instance, the control part 250 scans the frequency band available for the device including a communication function of the wireless LAN and determines whether or not the extended service set identifier (ESSID) of the device of interest (the imaging device 100) has been found.

When connection with the imaging device 100 utilizing wireless communication is possible (step S913), the control part 250 activates the simplified reproduction application (step S914).

For instance, in a case where the connection with the imaging device 100 utilizing wireless communication is possible (for instance, a case where the ESSID of the imaging device 100 has been found), it may be assumed that the power source of the imaging device 100 has been turned on and the distance to the imaging device 100 is small. In such a case, it is predictable that shooting using the imaging device 100 may be performed again and therefore the simplified reproduction application is activated.

In addition, in a case where connection with the imaging device 100 utilizing wireless communication is not possible (step S913), the control part 250 activates the reproduction/edition application (step S915).

For instance, in a case where a power source of the imaging device 100 is turned off when connection with the imaging device 100 utilizing wireless communication is not possible (for instance, a case where the ESSID of the imaging device 100 has not been found), there may be assumed such a case where the distance to the imaging device 100 is large. In such a case, it is predictable that shooting using the imaging device 100 has been finished and therefore the reproduction/edition application is activated.

### 3. Third Embodiment

For instance, an information processing device such as a smartphone is often used in the vertically directed state. On the contrary, it is assumed that an information processing device such as a smartphone is often used in a laterally directed state when performing the imaging operation with an imaging device mounted thereon.

Therefore, a third embodiment of the present technology describes an example of setting (switching to) the reproduction application on the basis of the posture of the information processing device (for instance, the direction in which the device is being used). The configuration of the imaging device and the information processing device in the third embodiment of the present technology is identical to that of the imaging device 100 and the information processing device 200 illustrated in FIGS. 1 to 3. Accordingly, individual devices in the third embodiment of the present technology are designated with reference signs identical to those in the first embodiment of the present technology, and the description thereof is partially omitted.

### [Operation Example of Information Processing Device]

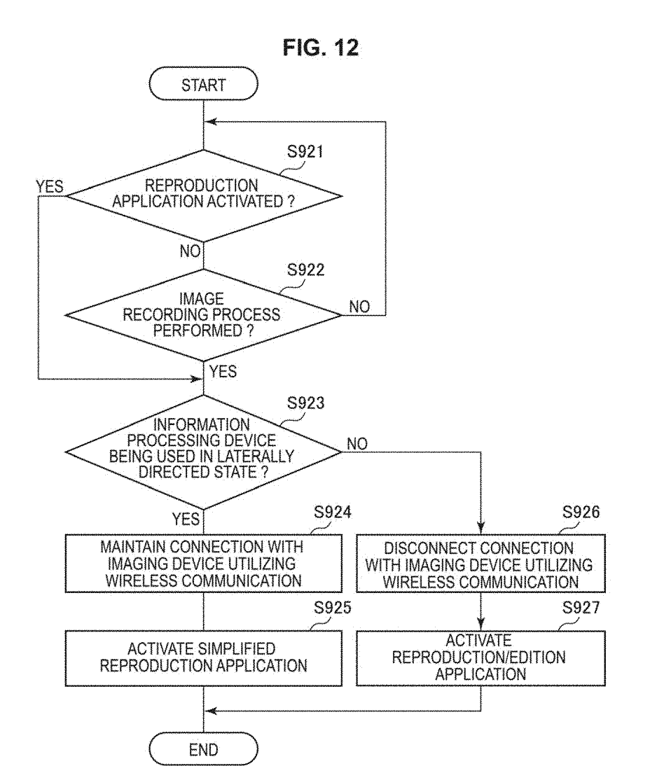

FIG. 12 is a flowchart illustrating one example of a processing procedure of the reproduction application setting process performed by the information processing device 200 according to the third embodiment of the present technology. FIG. 12 illustrates, similarly to FIGS. 10 and 11, an example of setting the reproduction application at a timing when activation of the reproduction application is instructed by the user's operation, or at a timing immediately after the image recording process is performed. Note that, since steps S921, S922, and S924 to S927 correspond to S901, S902, and S904 to S907 described in FIG. 10, detailed description thereof is omitted here.

In a case where activation of the reproduction application has been instructed (step S921), or the image recording process has been performed (step S922), the control part 250 determines whether or not the information processing device 200 is used in a laterally directed state (step S923).

In a case where the information processing device 200 is used in a laterally directed state (step S923), the process flow proceeds to step S924.

For instance, in a case where the information processing device 200 is used in the laterally directed state, it is assumed that the imaging operation is performed with the imaging device 100 mounted thereon, as illustrated in FIG. 4a. In such a case, it is predictable that shooting using the imaging device 100 may be performed again and therefore the simplified reproduction application is activated.

In addition, in a case where the information processing device 200 is not used in the laterally directed state (a case where the information processing device 200 is used in a vertically directed state) (step S923), the process flow proceeds to step S926.

For instance, it often happens that a general reproduction/edition application is designed for a vertically directed screen. Therefore, for instance, it is very likely that the reproduction/edition application is used in a case where the information processing device 200 is used in the laterally directed state. Accordingly, the reproduction/edition application is activated.

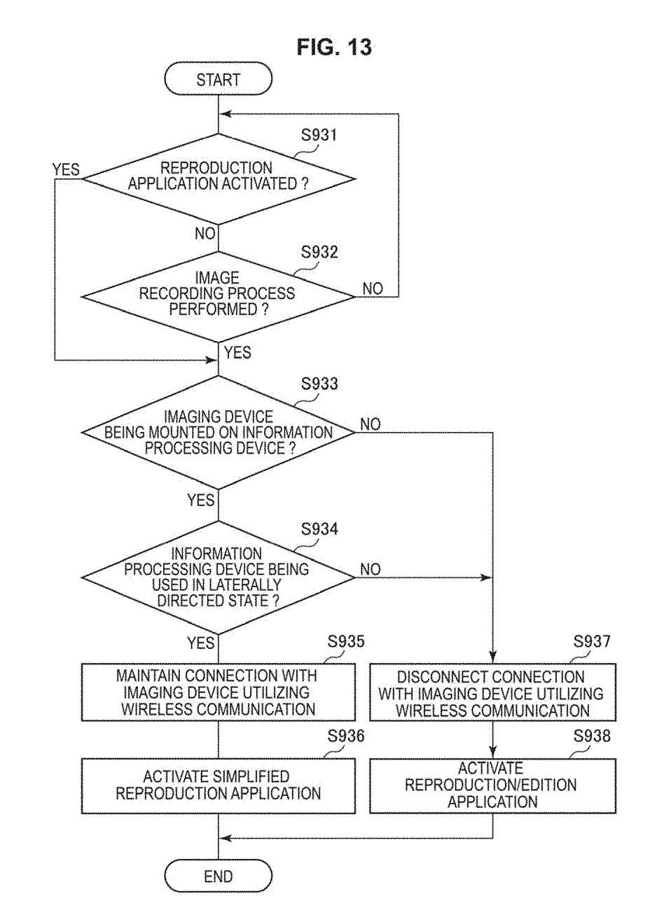

Note that, whether or not the information processing device 200 is used in the laterally directed state may be determined under a condition that the imaging device 100 is mounted on the information processing device 200. In other words, the first embodiment of the present technology and the third embodiment of the present technology may be combined. An example thereof is illustrated in FIG. 13.

### [Operation Example of Information Processing Device]

FIG. 13 is a flowchart illustrating one example of a processing procedure of the reproduction application setting process performed by the information processing device 200 according to the third embodiment of the present technology. Note that, since steps S931, S932, and S934 to S938 correspond to S921 to S927 described in FIG. 12 and step S933 corresponds to S903 described in FIG. 10, detailed description thereof is omitted here.

As has been thus described, it is possible to set a more appropriate reproduction application by determining whether or not the information processing device 200 is used in the laterally directed state under a condition that the imaging device 100 is mounted on the information processing device 200.

As has been thus described, according to the embodiments of the present technology, it is possible to select and set the most suitable reproduction application from two types of reproduction application, on the basis of the use mode of the information processing device 200. In other words, it is possible to use two types of reproduction applications differently, on the basis of the use mode of the information processing device 200. Accordingly, the user can quickly use an appropriate reproduction application according to the use mode of the imaging device 100 and the information processing device 200.

Note that, although an example of setting the reproduction application by control of the information processing device 200 has been described in the embodiments of the present technology, the reproduction application in the information processing device 200 may be set by control of the imaging device 100. For instance, the control part 140 of the imaging device 100 can control setting of the reproduction application in the information processing device 200, on the basis of information being sequentially transmitted from the information processing device 200. FIGS. 10 to 13 can be applied to the operation of the control part 140 of the imaging device 100 in such a case. In other words, the control part 140 of the imaging device 100 can perform control of setting the reproduction application, which reproduces an image generated by imaging operation, to the information processing device 200, on the basis of the use mode of the information processing device 200 connected utilizing wireless communication. Note that the information being sequentially transmitted from the information processing device 200 includes, for instance, presence or absence of an activation operation of a reproduction application, presence or absence of image recording instruction operation (e.g., shutter operation), and posture of the information processing device 200 (for instance, laterally directed state or vertically directed state).

While the embodiment of the present technology is described taking a cylindrical (columnar) imaging device 100 as an example, the embodiment of the present technology is applicable also to the imaging devices in other shapes, that can be attached to the other device. In addition, the second and third embodiments of the present technology can also be applied to an imaging device which is connectable to other devices utilizing wireless communication (e.g., Wi-Fi). Also, the embodiment of the present technology is described taking the information processing device 200 such as a smartphone or table terminal or the like as an example, the embodiment of the present technology is applicable also to the other devices that can be connected with the imaging device utilizing the wireless communication.

Also, the above-described embodiment illustrates one example for realizing the present technology, and matters in the embodiment and technology specifying matters in the scope of claims have correspondence relation respectively. Similarly, the technology specifying matters in the scope of claims and the matters in the embodiment of the present technology, to which the same names are attached, have the correspondence relation respectively. However, the present technology is not limited to the embodiment and can be realized by variously modifying the embodiment without departing from the spirit of the technology.

Also, the processing procedures described in the above embodiment may be recognized as a method having a series of the procedures, or may be recognized as a program for making a computer execute a series of the procedures or a non-transitory computer-readable recording medium having the program recorded thereon. As the recording medium, for instance, a computer disc (CD), a minidisc (MD), a digital versatile disc (DVD), a memory card, and a Blu-ray (R) disc or the like are usable.

Effects described in the present description are just examples, the effects are not limited, and there may be other effects.

Additionally, the present technology may also be configured as below.

(1)

An information processing device including:

a control part configured to perform control of setting, on the basis of a use mode of the information processing device, a reproduction application that reproduces an image generated by an imaging device connected utilizing wireless communication.

(2)

The information processing device according to (1),

wherein the control part determines the use mode of the information processing device at a timing when activation of the reproduction application is instructed based on a user's operation, or at a timing when a recording process of the image is performed based on a user's operation, and sets the reproduction application based on the determination result.

(3)

The information processing device according to (1) or (2),

wherein the control part sets either a first reproduction application which maintains connection with the imaging device utilizing wireless communication also after activation, or a second reproduction application which disconnects connection with the imaging device utilizing wireless communication after activation.

(4)

The information processing device according to (3),

wherein the control part sets the first reproduction application in a case where the imaging device is mounted on the information processing device, or sets the second reproduction application in a case where the imaging device is not mounted on the information processing device.

(5)

The information processing device according to (3),

wherein the control part sets the first reproduction application in a case where the imaging device and the information processing device are connected utilizing wireless communication, or sets the second reproduction application in a case where the connection between the imaging device and the information processing device utilizing the wireless communication is disconnected.

(6)

The information processing device according to (3),

wherein the control part sets the first reproduction application in a case where the information processing device is used in a laterally directed state, or sets the second reproduction application in a case where the information processing device is used in a vertically directed state.

(7)

The information processing device according to (1),

wherein the control part performs control of setting the reproduction application on the basis of a mounting state of the imaging device and the information processing device.

(8)

The information processing device according to (1),

wherein the control part performs control of setting the reproduction application on the basis of a connection state between the imaging device and the information processing device utilizing wireless communication.

(9)

The information processing device according to (1),

wherein the control part performs control of setting the reproduction application on the basis of a posture in which the information processing device is used.

(10)

An imaging device including a control part configured to perform control of setting, on the basis of a use mode of an information processing device connected utilizing wireless communication, a reproduction application that reproduces an image generated by an imaging operation to the information processing device.

(11)

An imaging system including:

an imaging device configured to provide an image generated by an imaging operation to an information processing device connected utilizing wireless communication; and

an information processing device configured to perform control of setting, on the basis of a use mode of the information processing device, a reproduction application which reproduces an image provided from the imaging device.

(12)

A method of controlling an information processing device, the method including:

a control procedure of setting, on the basis of a use mode of the information processing device, a reproduction application that reproduces an image generated by an imaging device connected utilizing wireless communication.

(13)

A program for causing a computer to execute a control procedure of setting, on the basis of a use mode of an information processing device, a reproduction application that reproduces an image generated by an imaging device connected utilizing wireless communication.

### REFERENCE SIGNS LIST

100 imaging device
110 imaging part
120 image processing part
130 storage part
140 control part
150 wireless communication part
160 operation reception part
161 to 163 operation member
170 lens barrel
180 adaptor
181, 182 attachment member
200 information processing device
210 posture detection part
220 operation reception part
221 to 223 operation member
230 wireless communication part
240 input/output part
241 input part
242 display part
250 control part
260 image processing part
270 storage part
280 sound output part
291 light emitting part
292 imaging part

1. An information processing device comprising:
a control part configured to perform control of setting, on the basis of a use mode of the information processing device, a reproduction application that reproduces an image generated by an imaging device connected utilizing wireless communication.

2. The information processing device according to claim 1,
wherein the control part determines the use mode of the information processing device at a timing when activation of the reproduction application is instructed based on a user's operation, or at a timing when a recording process of the image is performed based on a user's operation, and sets the reproduction application based on the determination result.

3. The information processing device according to claim 1,
wherein the control part sets either a first reproduction application which maintains connection with the imaging device utilizing wireless communication also after activation, or a second reproduction application which disconnects connection with the imaging device utilizing wireless communication after activation.

4. The information processing device according to claim 3,
wherein the control part sets the first reproduction application in a case where the imaging device is mounted on the information processing device, or sets the second reproduction application in a case where the imaging device is not mounted on the information processing device.

5. The information processing device according to claim 3,
wherein the control part sets the first reproduction application in a case where the imaging device and the information processing device are connected utilizing wireless communication, or sets the second reproduction application in a case where the connection between the imaging device and the information processing device utilizing the wireless communication is disconnected.

6. The information processing device according to claim 3,
wherein the control part sets the first reproduction application in a case where the information processing device is used in a laterally directed state, or sets the second reproduction application in a case where the information processing device is used in a vertically directed state.

7. The information processing device according to claim 1,
wherein the control part performs control of setting the reproduction application on the basis of a mounting state of the imaging device and the information processing device.

8. The information processing device according to claim 1,
wherein the control part performs control of setting the reproduction application on the basis of a connection state between the imaging device and the information processing device utilizing wireless communication.

9. The information processing device according to claim 1,
wherein the control part performs control of setting the reproduction application on the basis of a posture in which the information processing device is used.

10. An imaging device comprising a control part configured to perform control of setting, on the basis of a use mode of an information processing device connected utilizing wireless communication, a reproduction application that reproduces an image generated by an imaging operation to the information processing device.

11. An imaging system comprising:
an imaging device configured to provide an image generated by an imaging operation to an information processing device connected utilizing wireless communication; and
an information processing device configured to perform control of setting, on the basis of a use mode of the information processing device, a reproduction application which reproduces an image provided from the imaging device.

12. A method of controlling an information processing device, the method comprising:
a control procedure of setting, on the basis of a use mode of the information processing device, a reproduction application that reproduces an image generated by an imaging device connected utilizing wireless communication.

13. A program for causing a computer to execute a control procedure of setting, on the basis of a use mode of an information processing device, a reproduction application that reproduces an image generated by an imaging device connected utilizing wireless communication.
